(19) United States
(12) Patent Application Publication
(10) Pub. No.: US 2008/0064277 A1
(43) Pub. Date: Mar. 13, 2008

(54) Siphon-protective TPU compound material

(75) Inventors: Chung-Hu Hsiao, Taichung City (TW); Chien-Hua Yeh, Changhua County (TW)

Correspondence Address: BROWDY AND NEIMARK, P.L.L.C.;624 NINTH STREET, NW, SUITE 300, WASHINGTON, DC, 20001-5303, US

(73) Assignee: Tiong Liong Industrial Co., Ltd., Da-Ya Shiang (TW)

(21) Appl. No.: 11/647,383

(22) Filed: Dec. 29, 2006

(30) Foreign Application Priority Data
Sep. 13, 2006 (TW) 95133947

(51) Int. Cl. B32B 5/02

(52) U.S. Cl. 442/59; 442/64; 442/149; 442/152; 442/164

(57) ABSTRACT

A siphon protective thermoplastic polyurethane compound material having an intermediate fabric layer prepared from cotton, nylon, or polyester, a top covering layer of thermoplastic polyurethane film and a bottom covering layer of thermoplastic polyurethane film respectively covered on the top and bottom sides of the intermediate fabric layer, and a bonding layer prepared from alcohols having a total molecular weight below 100000 and respectively bonded in between the top and bottom sides of the intermediate fabric layer and the top and bottom cover layers of thermoplastic polyurethane film. The molecular weight of the alcohols is below 4000.

### BACKGROUND OF THE INVENTION

1. Field of the Invention

The present invention relates to laminated compound materials and more particularly, to a siphon-protective TPU (thermoplastic polyurethane) compound material comprised of fabric and thermoplastic polyurethane.

2. Description of the Related Art

FIGS. 1 and 2 illustrate a TPU (thermoplastic polyurethane) compound material according to the prior art. According to this design, the TPU (thermoplastic polyurethane) compound material 1 comprises a fabric layer 2, two TPU cover layers 4 respectively covered on the top and bottom sides of the fabric layer 2, and a bonding glue 3 sandwiched in between the top and bottom sides of the fabric layer 2 and the two TPU cover layers 4. The TPU (thermoplastic polyurethane) compound material is heated and processed in a vacuum generator so that the treated finished product has raised granular structures on it. This kind of TPU (thermoplastic polyurethane) compound material is not suitable to receive a siphon protection treatment. When the fabric layer is coated with a layer of coating for siphon protection, bonding of a TPU cover layer to the siphon protection treated fabric becomes not workable. Because the bonding glue is prepared from alcohol-based polymers, having the reactive equation as follows:

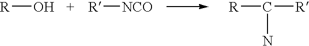

When the fabric is coated with PU, AC or Teflon for siphon protection, the Van der Waals force and surface tension of the fabric are weakened, causing a bonding problem of the TPU cover layer to the siphon protection treated fabric.

### SUMMARY OF THE INVENTION

The present invention has been accomplished under the circumstances in view. It is one object of the present invention to provide a thermoplastic polyurethane compound material, which has the characteristic of siphon protection. To achieve this object of the present invention, the siphon protective thermoplastic polyurethane compound material comprises an intermediate fabric layer prepared from cotton, nylon, or polyester, a top covering layer of thermoplastic polyurethane film and a bottom covering layer of thermoplastic polyurethane film respectively covered on the top and bottom sides of the intermediate fabric layer, and a bonding layer respectively bonded in between the top and bottom sides of the intermediate fabric layer and the top and bottom cover layers of thermoplastic polyurethane film. The total molecular weight of the adhesive of the bonding layer is below 100000 and the alcohols of the adhesive have a molecular weight below 4000.

### BRIEF DESCRIPTION OF THE DRAWINGS

FIG. 1 is a perspective view of a thermoplastic polyurethane compound material according to the prior art.

FIG. 2 is a sectional side view in an enlarged scale of the thermoplastic polyurethane compound material shown in FIG. 1.

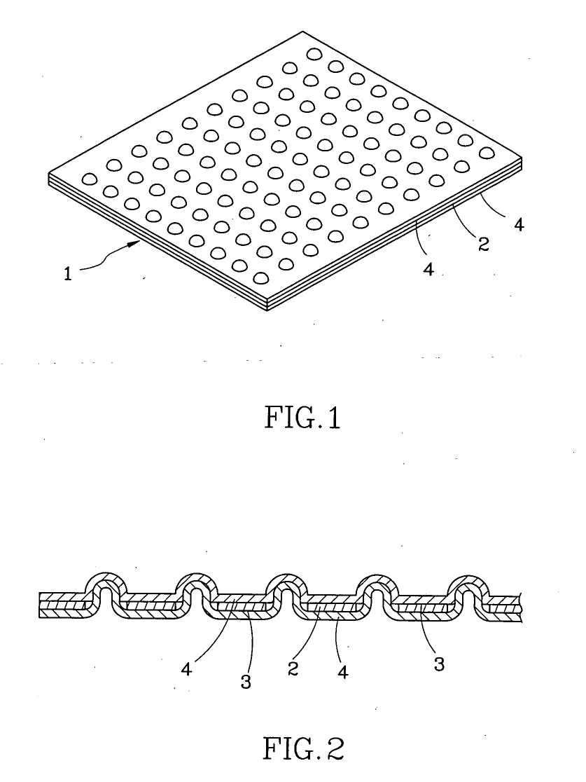

### DETAILED DESCRIPTION OF THE INVENTION

A siphon protective thermoplastic polyurethane compound material in accordance with the present invention, comprising: an intermediate fabric layer prepared from cotton, nylon, or polyester, a top covering layer of thermoplastic polyurethane film covered on one side, namely, the top side of the intermediate fabric layer, a bottom covering layer of thermoplastic polyurethane film covered on the other side, namely, the bottom side of the intermediate fabric layer, a first bonding layer bonded in between the top side of the intermediate fabric layer and the top covering layer of thermoplastic polyurethane film, and a second bonding layer bonded in between the bottom side of the intermediate fabric layer and the bottom covering layer of thermoplastic polyurethane film. The first bonding layer and the second bonding layer are respectively prepared from alcohols having a total molecular weight below 100000. The molecular weight of the alcohols (R-OH) is below 4000, or preferably within 2000˜3000.

The alcohols for the first bonding layer and the second bonding layer can be polyester, polyether, or polycarbonate. By means of the characteristic of low molecular weight, the first and second bonding layers cause an anchoring effect when applied to the intermediate fabric layer. By means of deep engagement of molecular mechanisms of long chain into fabric, the various layers of the siphon protective thermoplastic polyurethane compound material are interlocked. Therefore, after a siphon protection treatment of the intermediate fabric layer by means of PU, AC or Teflon coating, the first second bonding layers can still be fixedly bonded to the siphon protection treated intermediate fabric layer and the top and bottom covering layer of thermoplastic polyurethane film to fixedly secure the top and bottom covering layer of thermoplastic polyurethane film to the top and bottom sides of the siphon protection treated intermediate fabric layer. Therefore, a siphon protective thermoplastic polyurethane compound material made according to the present invention provides a satisfactory siphon protection effect for a wide range of application.

According to an alternate form of the present invention, a siphon protective thermoplastic polyurethane compound material is comprised of an intermediate fabric layer prepared from cotton, nylon, or polyester, a covering layer of thermoplastic polyurethane film covered on one side of the intermediate fabric layer, and a bonding layer bonded in between the intermediate fabric layer and the covering layer of thermoplastic polyurethane film. The bonding layer is prepared from alcohols having a total molecular weight below 100000. The molecular weight of the alcohols is below 4000, or preferably within 2000˜3000.

Although particular embodiments of the invention have been described in detail for purposes of illustration, various modifications and enhancements may be made without departing from the spirit and scope of the invention. Accordingly, the invention is not to be limited except as by the appended claims

What is claimed is:

1. A siphon protective thermoplastic polyurethane compound material comprising an intermediate fabric layer prepared from one of the materials including cotton, nylon, and polyester, said intermediate fabric layer having a top side and a bottom side, a top covering layer of thermoplastic polyurethane film covered on the top side of said intermediate fabric layer, a bottom covering layer of thermoplastic polyurethane film covered on the bottom side of said intermediate fabric layer, a first bonding layer bonded in between the top side of said intermediate fabric layer and said top covering layer of thermoplastic polyurethane film, and a second bonding layer bonded in between the bottom side of said intermediate fabric layer and said bottom covering layer of thermoplastic polyurethane film, wherein said first bonding layer and the second bonding layer are respectively prepared from alcohols having a total molecular weight below 100000 and the molecular weight of the alcohols is below 4000.

2. The siphon protective thermoplastic polyurethane compound material as claimed in claim 1, wherein said first bonding layer and the second bonding layer are respectively prepared from alcohols having a molecular weight of the alcohols preferably within 2000˜3000.

3. A siphon protective thermoplastic polyurethane compound material comprising an intermediate fabric layer prepared from one of the materials including cotton, nylon, and polyester, a covering layer of thermoplastic polyurethane film covered on one side of said intermediate fabric layer, and a bonding layer bonded in between said intermediate fabric layer and said covering layer of thermoplastic polyurethane film, wherein said bonding layer is prepared from alcohols having a total molecular weight below 100000 and the molecular weight of the alcohols is below 4000.

4. The siphon protective thermoplastic polyurethane compound material as claimed in claim 3, wherein said bonding layer is prepared from alcohols having a molecular weight of the alcohols preferably within 2000˜3000.
